(19) United States
(12) Patent Application Publication
(10) Pub. No.: US 2008/0155986 A1
(43) Pub. Date: Jul. 3, 2008

(54) G.P. power machine

(76) Inventor: Donald Philip Putnam, Mooresville, NC (US)

Correspondence Address: Don Putnam, 155 Harwell Rd., Mooresville, NC, 28117, US

(21) Appl. No.: 11/978,247

(22) Filed: May 9, 2006

(51) Int. Cl. F03B 17/04

(52) U.S. Cl. 60/721; 415/916

(57) ABSTRACT

This is a description of the submitted drawings—FIG. 1 —frontal view showing the weight belt enclosed in a frame suspended on gears mounted on a axel. FIG. 2—side view of frame supporting weight belt and angel the belt travels. FIG. 3—the best perspective and should be on the cover of this invention. It shows the direction the weight belt travels and location of sag rail necessary for optimum performance. FIG. 4—gives the spacing of the gears that support the belt and angel that the belt travels. FIG. 5—is a view of the weight belt with size specifications of the different component parts along with the rollers that contact the sag rail. FIG. 6—gives the specifications of three different parts of the machine, mainly for the manufactory. FIG. 7 —sketch of a support gear. manufactory info. FIG. 8—picture of assembled prototype to support theory of the machine.

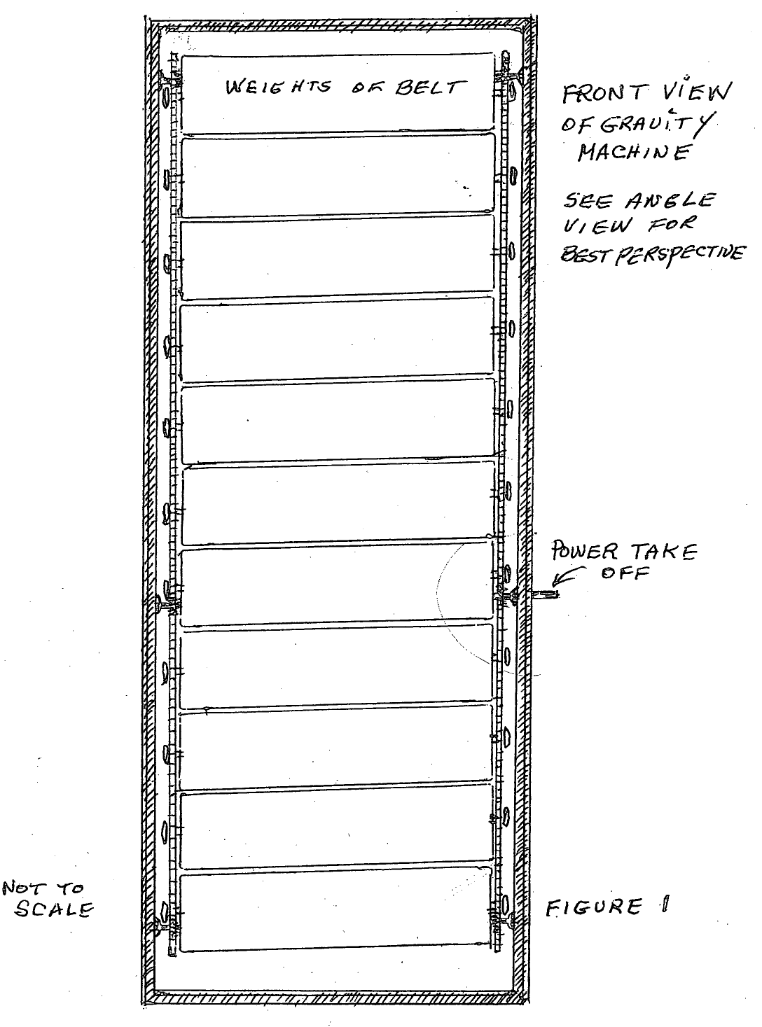

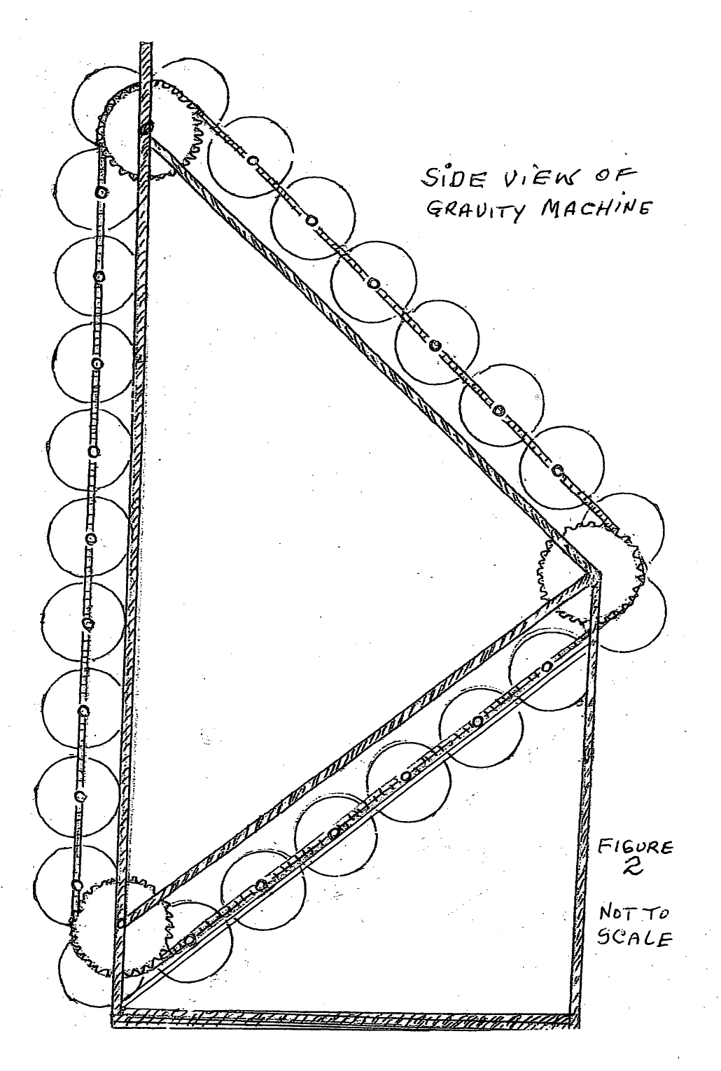

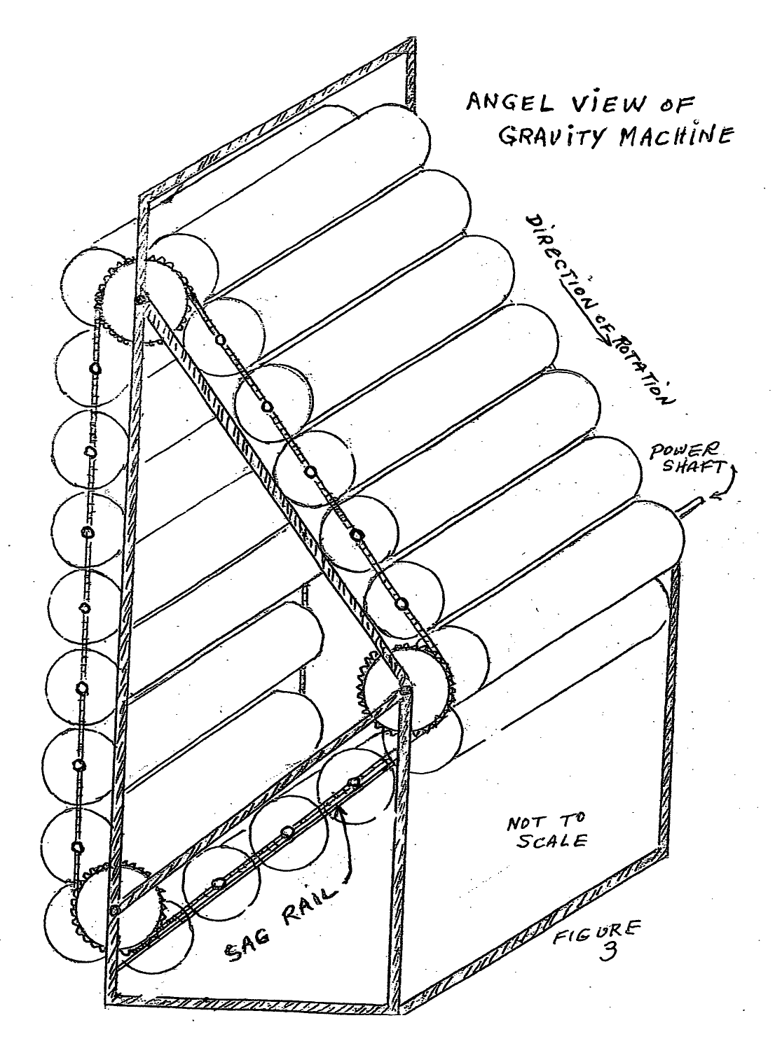

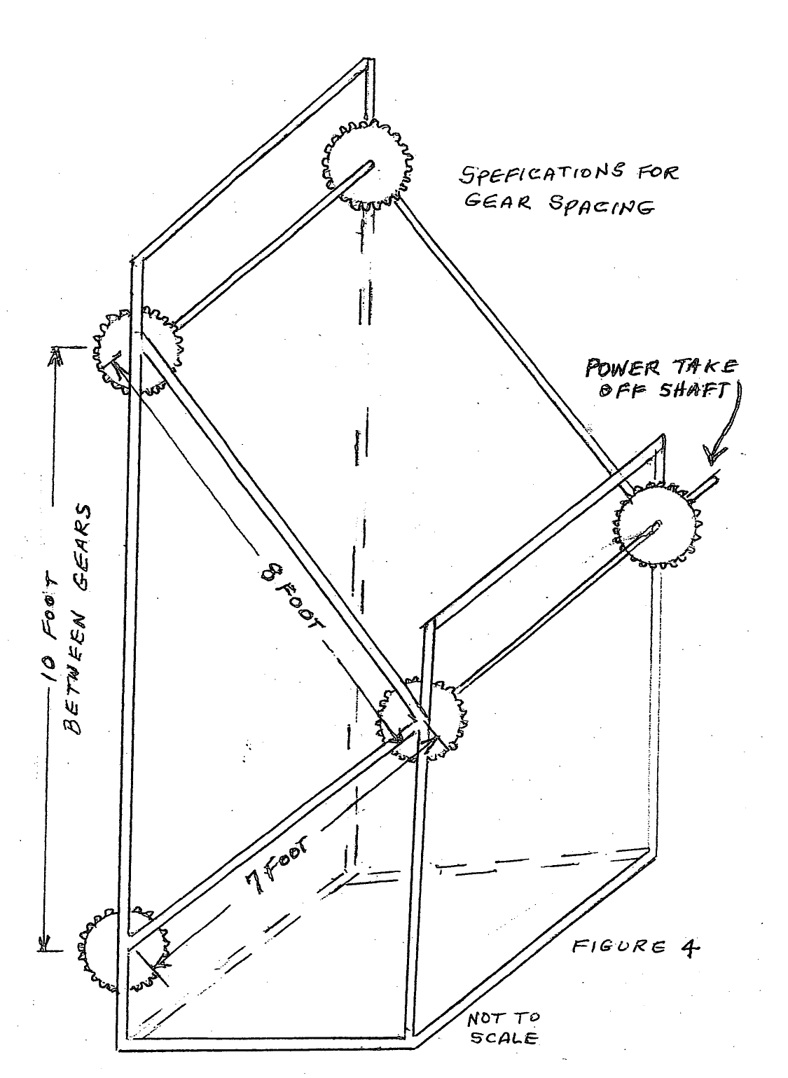

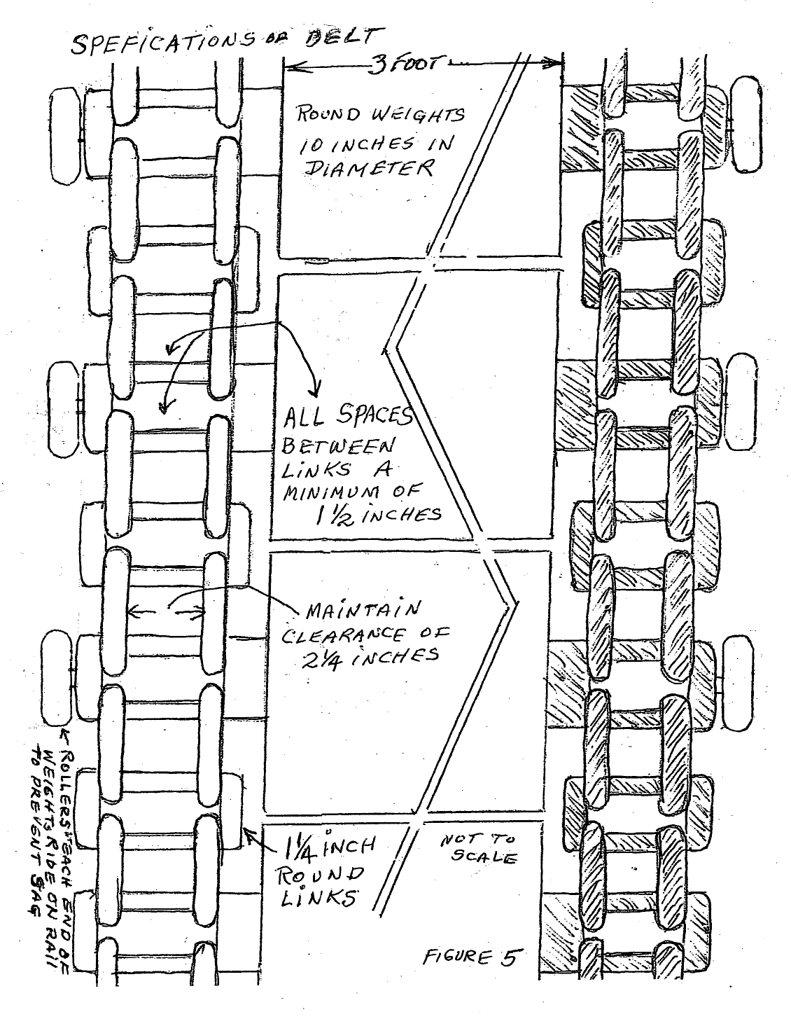

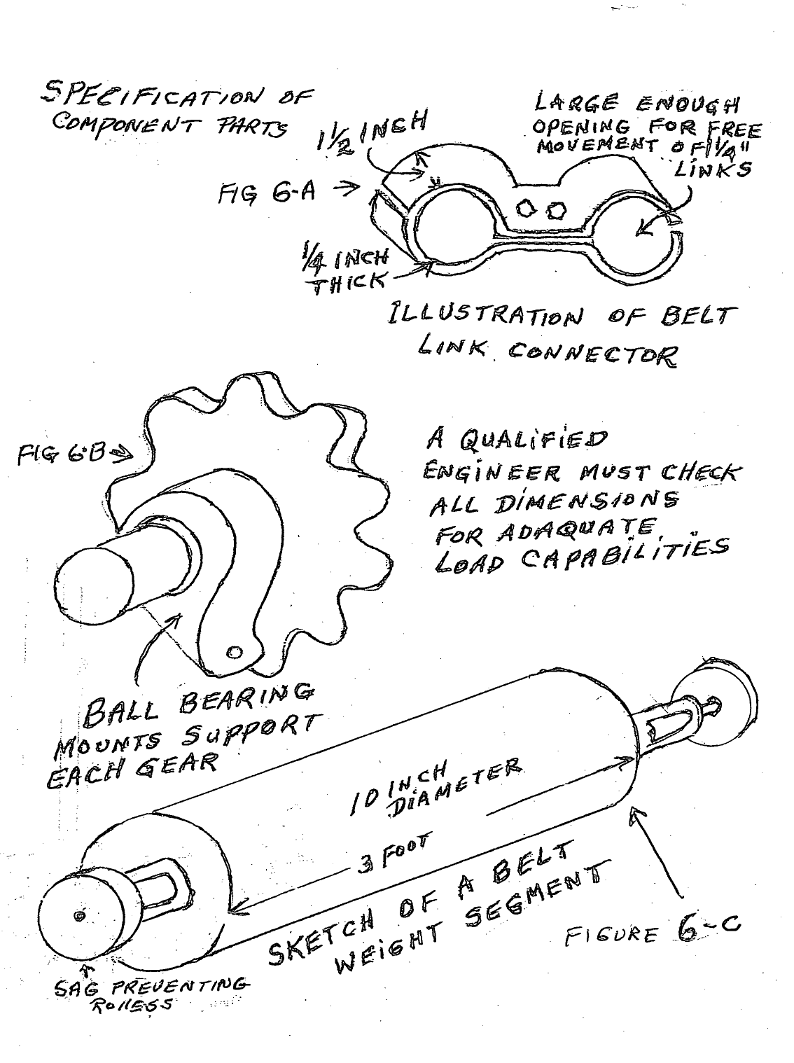

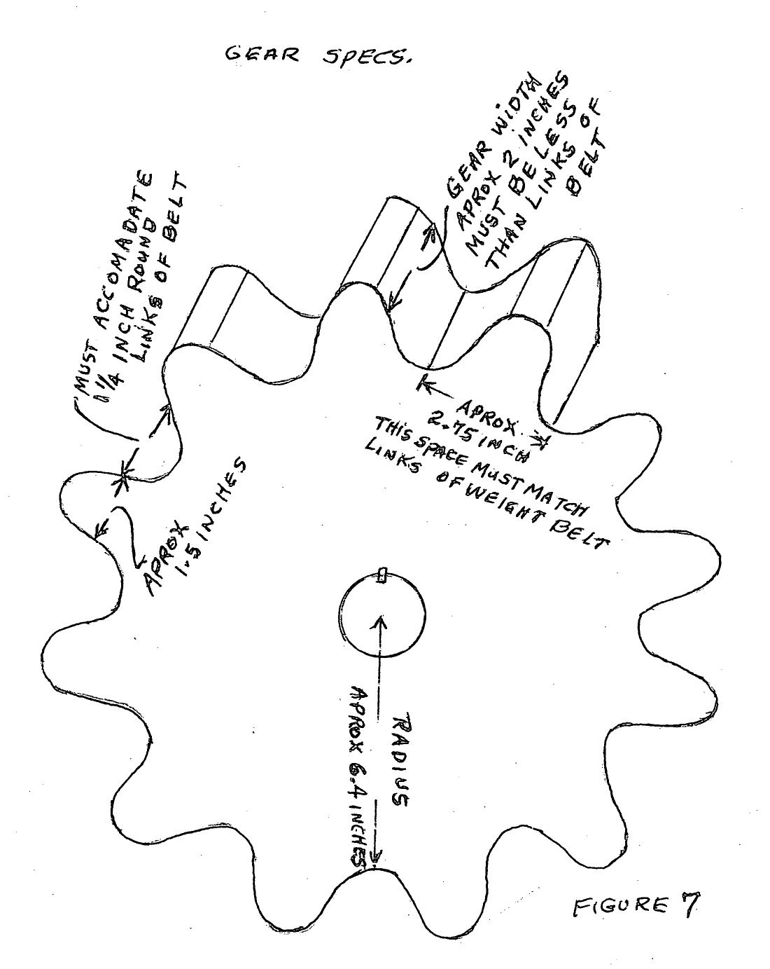

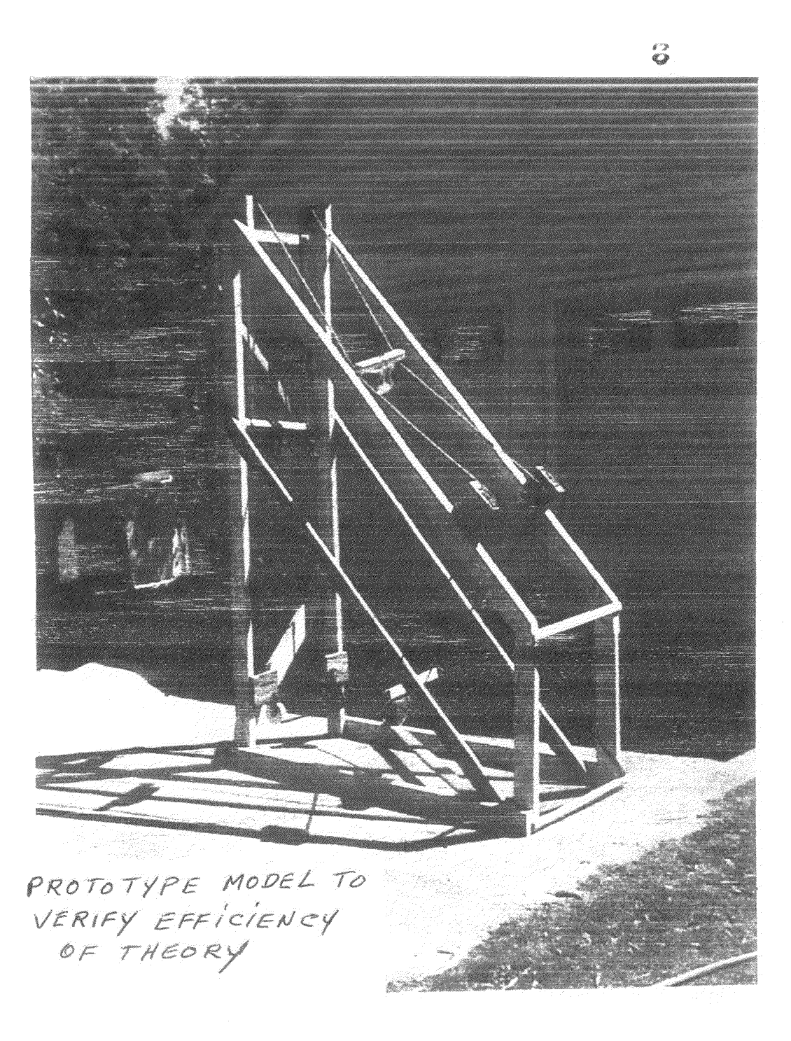

### DETAILED DESCRIPTION AND OBJECT OF USE

My gravity machine is composed of a heavy metal frame that supports a rotating weight belt. This belt is comprised of cylindrical weights connected together by links on each side of the belt. The belt is supported by matching gears, mounted on axels, at the top, bottom, and out at an angle on one side. The belt travels up to the top gears, rotates over and travels down at aprox. 45 degrees for a distance of 8/10ths of the vertical height, then returns back to the bottom gears a Distance of 7/10ths of the vertical height. There are support gears at all changes in the belts rotation. The angled out side of the weight belt comprises 50% more weight than the vertical side. This additional weight on the angled out side causes the belt to continually rotate producing torque power on the power take off axel.

The machine does not require a fossil fuel to operate it, therefore non polluting, and very I inexpensive to operate. This machine can be replicated in a much larger proportion than in my application, thus making it useful for electric generation by a utility company. It could be used to pump water and has unlimited uses.

1. I, Don Putnam, applicant Ser. No. 11/978,247 Filing or 371(C) Date May 9, 2006 have invented a gravity propelled power machine. Gravitational pull causes the weight belt, that extends out on one side, to revolve, producing torque power. It does not require a fossil fuel for it's operation and therefore it is non polluting. It produces torque power to run all kinds of machinery and when connected to a generator, it will produce electricity.
I request patent protection for all produced dimensions of my gravity power machine and any similar gravity propelled power machine.
